(19) United States
(12) Patent Application Publication
(10) Pub. No.: US 2014/0019256 A1
(43) Pub. Date: Jan. 16, 2014

(54) SELECTING ADVERTISEMENT FOR PRESENTATION USING PREVIOUSLY STORED DATA CORRESPONDING TO IDENTIFIED CUSTOMER

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/549,294

(22) Filed: Jul. 13, 2012

(51) Int. Cl. G06Q 30/02

(52) U.S. Cl. 705/14.65

(57) ABSTRACT

A method is disclosed for selecting an advertisement. The method may begin with identifying a computer system comprising a point-of-sale system and an expert system. The computer system may store first data corresponding to a customer. After this storing, the point-of-sale system may be used to conduct a point-of-sale transaction involving the customer and one or more items. The computer system may generate a plurality of advertisements, each comprising a machine-readable code encoded with a transaction identification unique to the transaction. During the transaction, a link between the customer and the first data may be established. Accordingly, the first data may be passed to the expert system. The expert system may use the first data to identify or predict which advertisement of the plurality of advertisements is most likely to elicit a desired response from the customer. The point-of-sale system may then present that advertisement to the customer.

### FIELD OF THE INVENTION

This invention relates to point-of-sale systems and more particularly to systems and methods for using past and/or present purchase data to determine which advertisement to present at a point-of-sale.

### BACKGROUND OF THE INVENTION

Many point-of-sale (POS) systems currently in use today do not support important emerging technologies, services, and marketing opportunities. For example, many POS systems are limited in their ability to intelligently determine which advertisement will perform the best when presented at a point-of-sale. As a result, those POS systems cannot effectively implement many novel methods and services that make use of advertisements. Accordingly, what is needed is an apparatus and method expanding the ability of a wide variety of POS systems, include legacy POS systems, to determine which advertisement or advertisements to present in connection with a particular transaction.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a point-of-sale (POS) system for implement methods in accordance with the present invention;

FIG. 2 is a schematic block diagram of one embodiment of multiple POS systems in accordance with the present invention operating in the context of an enterprise-wide system;

FIG. 3 is a schematic block diagram of one embodiment of receipt in accordance with the present invention;

FIG. 4 is an illustration showing how a card reader (e.g., credit card reader, debit card reader) may be used as a customer-facing display in certain embodiments in accordance with the present invention;

FIG. 5 is a schematic block diagram of one embodiment of an image module in accordance with the present invention;

FIG. 6 is a schematic block diagram of one embodiment of a testing module in accordance with the present invention;

FIG. 7 is an illustration of one embodiment of an advertisement displaying content and a machine-readable code in accordance with the present invention;

FIG. 8 is an illustration of an alternative embodiment of an advertisement displaying content and a machine-readable code in accordance with the present invention;

FIG. 9 is a schematic block diagram of one embodiment of a learning module in accordance with the present invention;

FIG. 10 is a block diagram of one embodiment of a method for using current purchase data to determine which advertisement to present in accordance with the present invention;

FIG. 11 is a block diagram illustrating the flow of data within one embodiment of system in accordance with the present invention; and

FIG. 12 is a block diagram of one embodiment of a method for using previously collected data (e.g., previous purchase data) to determine which advertisement to present in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for using purchase data to determine which advertisement to present at a point-of-sale. For example, in selected embodiments, it may be beneficial to use current purchase data (e.g., data characterizing a current or pending transaction at a POS) to determine which advertisement to present via a paper receipt printed by a POS system, a customer-facing display connected to a POS system, or the like. Alternatively, or in addition thereto, it may be beneficial to use data previously collected (e.g., previous purchase data, demographic data collected from an application form submitted previously, or the like) to determine which advertisement to present.

In selected embodiments, an advertisement may include a call to action inviting or motivating a customer to take a particular step or action. To increase the likelihood that a consumer will respond favorably to the call to action, an advertisement may include a machine-readable code. Upon scanning the code, a consumer may be directed to a desired website or resource, initiate the download of a particular application or resource, or the like.

In certain embodiments, a machine-readable code may comprise a two-dimensional barcode (e.g., a Quick Response (QR) Code). The data encoded within a machine-readable code may vary between different embodiments and different purposes or goals of the advertisement. In selected embodiments, a machine-readable code may encode a transaction identification (ID) uniquely identifying a particular transaction (e.g., purchase, return, or the like). Alternatively, or in addition thereto, a machine-readable code may encode an advertisement ID (e.g., an ID indicating which particular combination of call to action, graphics, or the like accompanied the machine-readable code).

In general, the purpose of an advertisement and the various components thereof may be to benefit, economically or otherwise, a consumer, an entity (e.g., an entity selling goods or services to the consumer), or some combination thereof. For example, in selected embodiments, an advertisement may support or enable storage of transaction data, budgeting, electronic search of transaction data, couponing, shopping lists, electronic backup of transaction data, sharing of transaction data with family, friends, and/or co-workers, tracking of expenses for business or tax purposes, or the like or combinations or sub-combinations thereof. In certain embodiments, one purpose of an advertisement may be to transition a customer from using paper receipts to using electronic (i.e., paperless) receipts. This purpose, as well as others mentioned above, may be furthered by using purchase data (e.g., past and/or present purchase data) to determine which advertisement has the greatest likelihood of success and should, therefore, be presented at a point-of-sale.

For example, after multiple advertisements have been obtained or generated, a POS system may conduct a transaction. In association with the transaction, one or more characteristics (e.g., one or more pieces of data) corresponding thereto may be identified. For example, any portion of the data typically associated with a paper receipt may be identified. Alternatively, or in addition thereto, a system may link a current customer with one or more records contained with the system. Once this link has been established, then the characteristics or data previously stored (or a portion thereof) may be used in connection with the transaction at hand. Using one or more of these characteristics, a system (e.g., an expert system) in accordance with the present invention may identify or predict which advertisement or advertisements are most likely to elicit a desired response with the customer. The advertisement or advertisements may then be presented to the customer.

Should a customer feel so inclined, he or she may scan a machine-readable code of an advertisement presented to him or her. The fact that a particular advertisement was scanned may be noted and recorded. Using the data collected, a system in accordance with the present invention may calculate a success rate for the one or more advertisements presented. Information (e.g., facts, trends, or the like) may be learned from the respective success rates and the underlying statistical information. Accordingly, the information learned may be used to update an expert system so that it will perform better in the future. This process or certain portions thereof may be iterated to progressively improve the rate at which one or more purposes behind an advertisement are accomplished.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

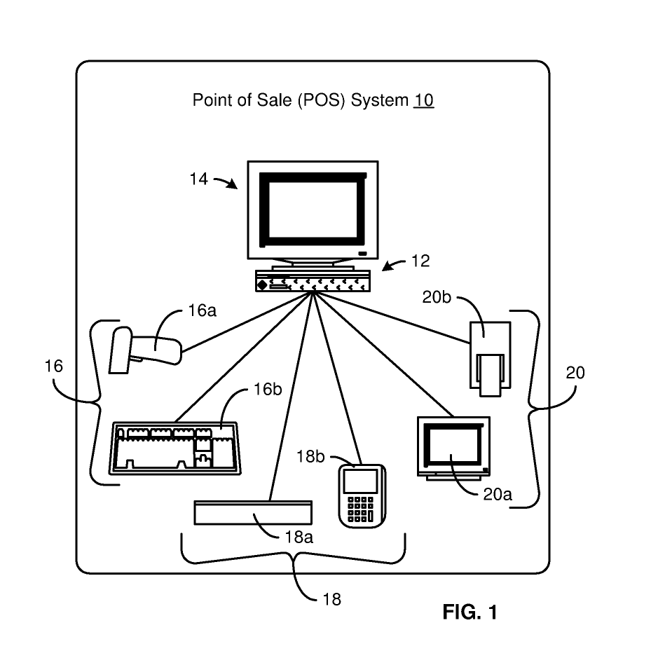

Referring to FIG. 1, in selected embodiments, the hardware, software, or hardware and software of a POS system 10 may be configured to implement one or more methods in accordance with the present invention. For example, a POS system 10 may be manufactured, programmed, modified, or upgraded to support image-embedding capabilities.

A POS system 10 in accordance with the present invention may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 in accordance with the present invention may include an accounting interface to pass certain information to one or more in-house or independent accounting applications.

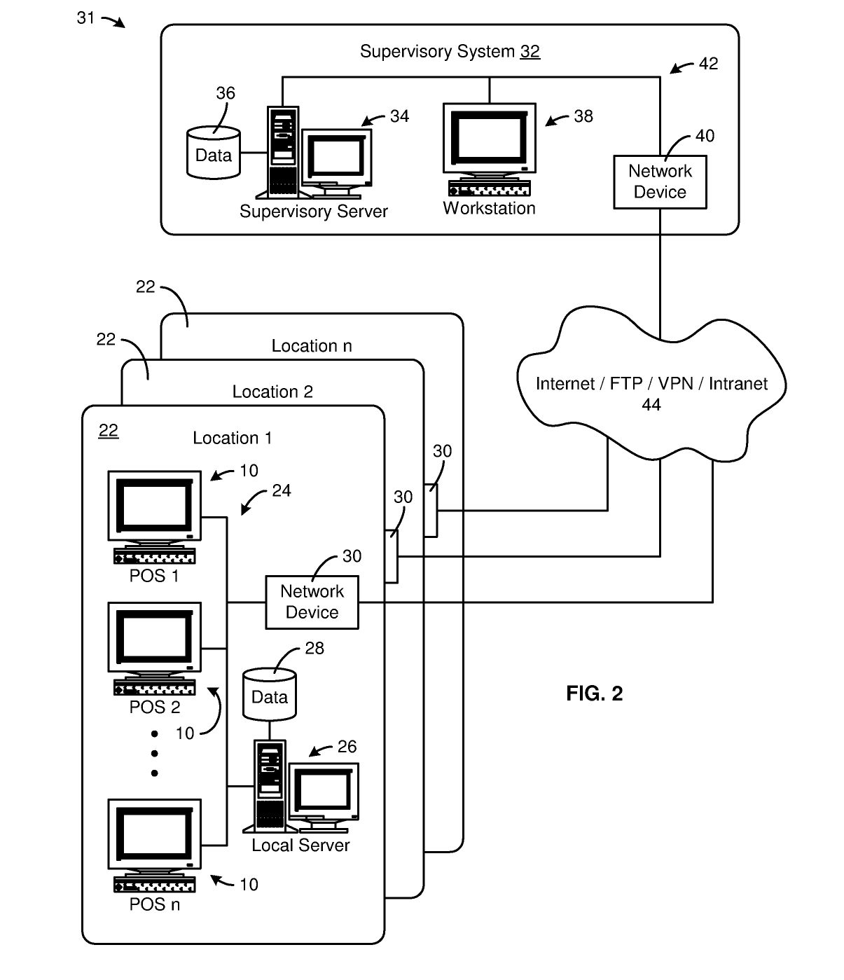

Referring to FIG. 2, in selected embodiments, a POS system 10 may operate substantially independently, as a stand-alone unit. Alternately, a POS system 10 in accordance with the present invention may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 in accordance with the present invention may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

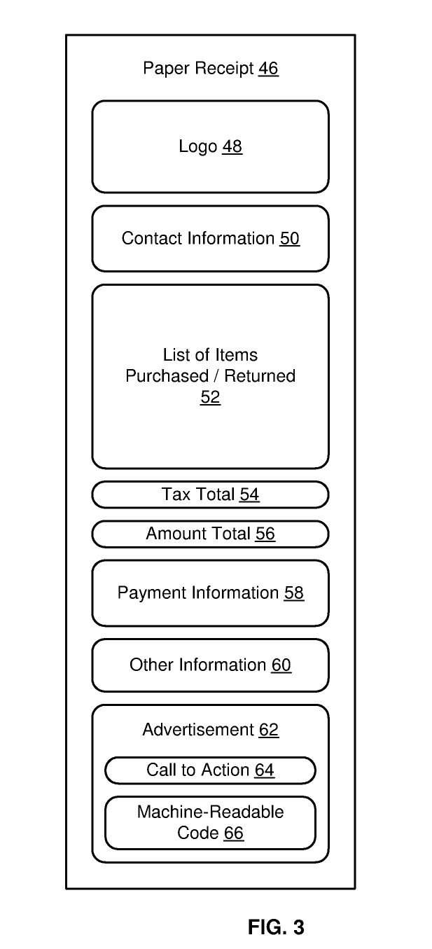

Referring to FIG. 3, in selected embodiments in accordance with the present invention, a POS system 10 may output a receipt 46. For example, a printer 20b of a POS system 10 may output a paper receipt 46. A receipt 46 may perform various functions. Primarily, a receipt 46 may document a financial transaction (e.g., sale or return). However, a receipt 46 may also deliver one or more marketing messages to a consumer. In selected embodiments, a receipt 46 may include a logo 48, contact information 50, a list 52 of items purchased or returned, a total 54 indicating the sales tax assessed or returned, a total 56 indicating 56 the amount paid or returned, payment information 58, other information 60, or the like or combinations or sub-combinations thereof.

A logo 48 may reinforce the brand and image of the associated entity within the mind of a consumer. By including contact information 50 on a receipt 46, an entity may ensure that a customer has ready access to one or more physical addresses, Internet address, telephone numbers, facsimile numbers, hours of operation, or the like or combinations or sub-combinations thereof. One or more of a list 52 of items purchased or returned, a total 54 indicating the sales tax assessed or returned, a total 56 indicating 56 the amount paid or returned, and payment information 58 (e.g., date of transaction, an indication of method of payment, an indication of which credit or debit card was used, etc.) may be included to document important details of a transaction.

Other information 60 may be included within a receipt 46 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

In selected embodiments, a receipt 46 may include an advertisement 62. An advertisement 62 may include a call to action 64 inviting or motivating a recipient of the receipt 46 to take a particular step or action. For example, a call to action 64 may invite or motive a consumer to visit a particular website, download a particular application, or the like. To increase the likelihood that a consumer will respond favorably to the call to action 64, an advertisement 62 may include an enabler facilitating the desired step or action. For example, in selected embodiments, an advertisement 62 may include a machine-readable code 66. Upon scanning the code 66 (e.g., scanning the code 66 using a camera on a mobile computing device such as mobile telephone, personal digital assistant (PDA), or tablet computer or reader, or the like), a consumer may be directed to a desired website (e.g., a particular URL), initiate the download of a particular application, initiate the download of a resource corresponding to a transaction (e.g., an electronic receipt), or the like.

A machine-readable code 66 may comprise a barcode. For example, in certain embodiments, a machine-readable code 66 may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

The data encoded within a machine-readable code 66 may vary between different embodiments and different purposes (e.g., purposes or goals of an advertisement 62). In selected embodiments, a machine-readable code 66 may encode a transaction identification (ID). A transaction ID may uniquely identify a particular transaction (e.g., a transaction documented by a corresponding receipt 46). Alternatively, or in addition thereto, a machine-readable code 66 may further encode an advertisement ID (e.g., an ID indicating which particular combination of call to action 64, graphics, or the like accompanied the machine-readable code 66). A machine-readable code 66 may also encode a web address or URL.

As with a machine-readable code 66, the nature or characteristics of an advertisement 62 and call to action 64 may vary according to a purpose thereof. In general, the purpose of an advertisement 62 and the various components 64, 66 thereof may be to benefit, economically or otherwise, a consumer, an entity (e.g., an entity issuing the receipt 46), or some combination thereof. For example, in selected embodiments, the purpose of an advertisement 62 may be to transition a customer from using paper receipts 46 to using electronic (i.e., paperless) receipts.

At one level, the use of electronic receipts may conserve natural resources by reducing the need for and consumption of paper. However, the use of electronic receipts may have other advantages to both a consumer and an entity issuing the electronic receipts. For example, electronic receipts may enable a consumer to more easily collect and keep a highly detailed record of his or her spending. Entities issuing electronic receipts may benefit from additional marketing opportunities that the electronic receipts provide.

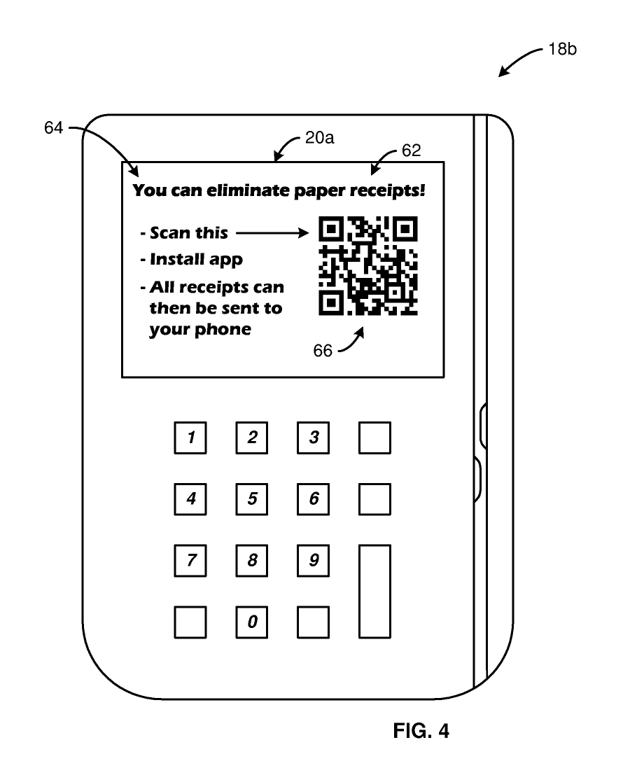

Referring to FIG. 4, as set forth hereinabove, an advertisement 62 may be presented to a customer via a printed receipt 46. Alternatively, or in addition thereto, an advertisement 62 (e.g., the same advertisement 62 or a different advertisement 62) may be presented to a customer via some other output mechanism 20. For example, in selected embodiments, one or more advertisements 62 may be presented to a customer via a customer-facing display 20a screen 20a.

A customer-facing display 20a may take various forms. In selected embodiments, a customer-facing display 20a may be embodied as a stand-alone monitor dedicated to presenting information, advertisements 62, or the like to a customer at a POS. Alternatively, a customer-facing display 20a may be a multi-use screen capable of performing various functions. For example, in certain embodiments, a customer-facing display 20a may be embodied as a screen on a card reader 18b. That is, during at least some portion of a transaction, an advertisement 62 may be displayed on a screen or a portion of a screen of a card reader 18b.

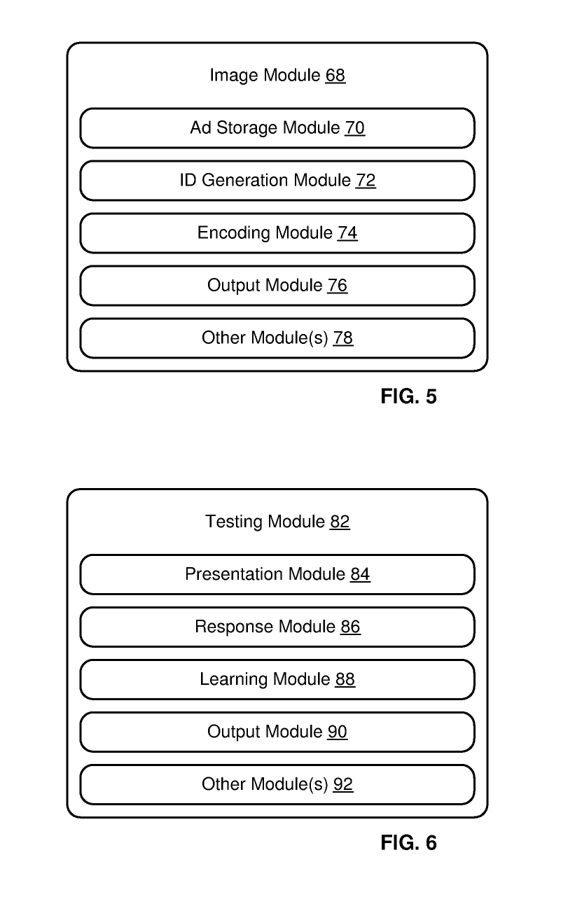

Referring to FIG. 5, in general, consumers rely heavily on visual cues. Accordingly, an advertisement 62 may include a significant graphical component. That is, an advertisement 62 in accordance with the present invention may impact a consumer through images, stylization, or the like, rather than just through plain text. Thus, in certain embodiments, some portion or all of an advertisement 62 may be passed within a POS system 10 as an image and printed or displayed as an image, not as text. For example, an advertisement 62 (or a significant portion thereof) may be passed to a receipt printer 20b or customer-facing display 20a in a stream including a raster-coded image or bitmap.

In selected embodiments, an image module 68 may be tasked with obtaining or generating one or more images associated with an advertisement 62. For example, an image module 68 may obtain, generate, and/or assemble one or more advertisements 62 and deliver the one or more advertisements 62 to a receipt printer 20b, customer-facing display 20b, or the like or some combination thereof. An image module 68 may include any suitable arrangement of sub-components or modules. In certain embodiments, an image module 68 may include a storage module 70, ID generation module 72, encoding module 74, and output module 76, one or more other modules 78 as desired or necessary, or the like or some combination or sub-combination thereof.

A storage module 70 may enable an image module 68 to receive, store, index, and/or retrieve one or more images. For example, in certain embodiments, a storage module 70 may provide or support the receiving, storing, indexing, and/or retrieving of one or more image templates used in assembling one or more advertisements 62. An image template may be an image (e.g., a digital image, raster-coded image, bitmap, or the like) coded to display some content and one or more placeholders.

The content of an image template may have any suitable form. In selected embodiments, the content of a template may include one or more graphical elements (e.g., non-readable elements, shapes, icons, illustrations, or the like), one or more readable elements (e.g., stylized text or a written call to action 64 in image form), or the like or some combination or sub-combination thereof. A placeholder of an image template may correspond to, and provide, a space for a machine-readable code 66, transaction-specific image, or the like.

That is, one or more templates may be prepared and stored in memory (e.g., some memory device or collection of memory devices within a POS system 10, location 22, or enterprise-wide system 31) before a transaction at a POS system 10 is initiated. For example, a graphic artist or designer may prepare one or more templates highlighting different messages, themes, or the like applicable to different situations or transactions long before a particular transaction is initiated at a POS system 10. Since a machine-readable code 66 may be encoded with transaction-specific information, it may not be included within a template at the time of its original creation.

However, the placement (e.g., location, size, orientation, etc.) of a machine-readable code 66 or other transaction-specific image with respect to the content may be important to the work and goals of the artist or designer. Accordingly, the artist or designer may incorporate one or more placeholders within a template. The location, size, and orientation of a placeholder may respectively indicate the desired location, size, and orientation of the machine-readable code 66, transaction-specific image, or the like in the final product (e.g., the final image presented to a customer).

An ID generation module 72 may generate one or more identifications to be incorporated within an advertisement 62. For example, an ID generation module 72 may obtain or generate an ID unique to each transaction processed within a POS system 10, location 22, or enterprise-wide system 31. Alternatively, or in addition thereto, an ID generation module 72 may obtain or generate an ID for each advertisement 62 (e.g., each advertisement 62 of different content) processed within a POS system 10, location 22, or enterprise-wide system 31.

An encoding module 74 may generate a machine-readable code 66 encoded with various data, including a transaction ID, advertisement ID, uniform resource identifier (URI), or the like or some combination or sub-combination thereof. In selected embodiments, a machine-readable code 66 may be embodied as a digital image coded to display content that is machine-readable. For example, in certain embodiments, a machine-readable code 66 may be embodied as a digital image coded to display a QR Code of the like.

Once generated, a machine-readable code 66 may be applied to a template. Accordingly, a resulting advertisement 62 may comprise a digital image formed when an image template is modified such that one or more placeholders therewithin are respectively replaced with one or more machine-readable codes 66, transaction-specific images (e.g., non-readable images or readable images displaying timestamps, dates, website information (URL), etc.), or the like or combinations or sub-combinations thereof.

A completed advertisement 62 may be stored within a memory device or collection of memory devices corresponding to a POS system 10, location 22, enterprise-wide system 31, or some other resource. For example, in selected embodiments, an output module 76 may pass an advertisement 62 to the memory of a receipt printer 20b. Alternatively, or in addition thereto, an advertisement 62 may be passed to or read by a customer-facing screen 20a for display thereon.

The various functions or modules of an image module 68 may be enacted or implemented by any suitable system or component thereof. For example, in selected embodiments, an image module 68 may be implemented partially or entirely as a “virtual printer” or monitor driver residing on a primary computer 12 of a POS system 10. Alternatively, one or more functions or modules of an image module 68 may be enacted or implemented by a “box” positioned in the line of communication between a primary computer 12 and a receipt printer 20b or between a primary computer 12 and a customer-facing display 20a. A box may monitor and modify certain communications passing between the computer 12 and the printer 20b or display 20a. A box may access a LAN 24 or WAN 44 to gather additional resources or information as necessary.

In still other embodiments, one or more functions or modules of an image module 68 may be distributed across various hardware devices, including a primary computer 12 of a POS system 10, a local server 26, a supervisory server 34, an onsite resource, an offsite resource, or the like or combinations or sub-combinations thereof. Thus, systems and methods in accordance with the present invention may be adapted to a wide variety of situations, including more rigid legacy systems.

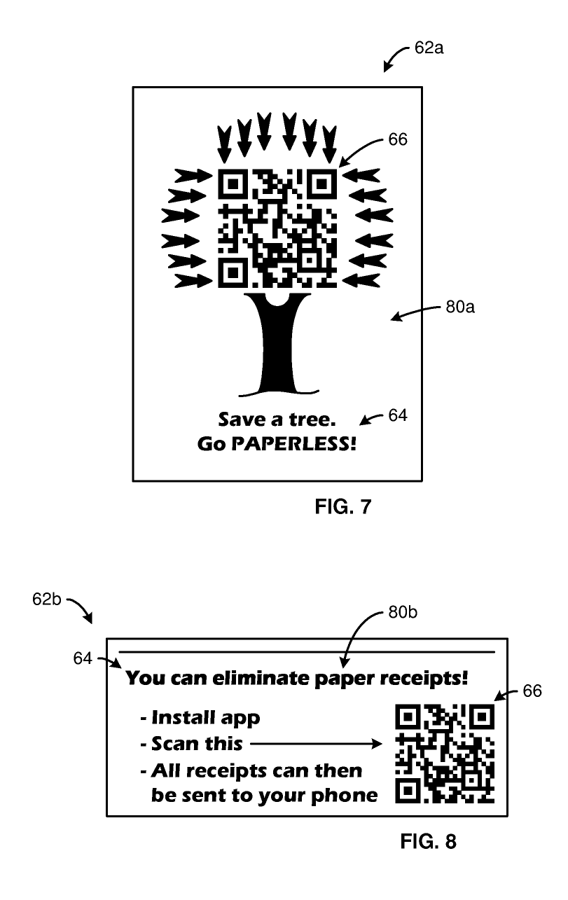

Referring to FIGS. 6-8, in selected embodiments, data reflecting real world performance of one or more advertisements 62 may enable or support improvement in that performance. That is, different advertisements 62 may have different success rates. A success rate may reflect a comparison between the number of times an advertisement 62 is presented to consumers (e.g., a number of impressions) and the number of times consumers act on the advertisement 62. By tracking the success rates of one or more advertisements 62, better, more successful advertisements 62 may be created, tested, and deployed.

For example, a first advertisement 62a may include first content 80a and a first machine-readable code 66a. A second advertisement 62b may have second content 80b distinct in some manner from the first content 80a and a second machine-readable code 66b. Using one or more POS systems 10 within a location 22, enterprise-wide system 31, or the like, the first and second advertisements 62a, 62b may each be presented to a certain number of consumers via a printed receipt 47, a customer-facing display 20a, or the like or some combination thereof. Each machine-readable code 66 presented as part of the advertisements 62a, 62b may include an advertisement ID identifying the advertisement 62a, 62b associated therewith. Accordingly, when a machine-readable code 66 is scanned by a consumer, data identifying the associated advertisement 62a, 62b may be collected.

By dividing the number of times consumers act on an advertisement 62a, 62b (e.g., the number of unique or first time scans of machine-readable codes 66 associated with an advertisement 62a, 62b) by the number of times the advertisement 62a, 62b is presented to consumers, a success rate for each advertisement 62a, 62b may be determined. Accordingly, one advertisement 62a, 62b may be determined to have performed better than another advertisement 62b, 62a. Such data may enable “A/B testing,” multivariate testing, or other designed experiments or learning that supports data-driven improvement. For example, advertisements 62 that perform better may be displayed to customers more frequently (e.g., if an advertisement 62 performs better in one or more aisles, POS systems 10, departments, stores 22, regions, enterprises 31, or the like, it may be displayed more frequently in one or more of those locations).

In selected embodiments, a testing module 82 may enable, support, or manage one or more designed experiments. For example, a testing module 82 may collect, store, and process data corresponding to advertisement impressions and responses to highlight or identify certain facts, trends, or the like that may be leveraged for benefit or improvement. A testing module 82 may include any suitable arrangement of sub-components or modules. In certain embodiments, a testing module 82 may include a presentation module 84, response module 86, learning module 88, output module 90, one or more other modules 92 as desired or necessary, or the like or some combination or sub-combination thereof. The various functions or modules of a testing module 82 may be supported by or run on one or more hardware devices, including a primary computer 12 of a POS system 10, a local server 26, a supervisory server 34, an onsite resource, an offsite resource, or the like or combinations or sub-combinations thereof.

A presentation module 84 may collect, store, and process data corresponding to advertisement presentations or impressions. For example, a presentation module 84 may collect a count of how many times an advertisement 62 (e.g., one or more advertisements 62 having identical content 80 but different encodings within respective machine-readable codes 66) is presented on receipts 46 or customer-facing displays 20a. A presentation module 84 may collect this information from one or more POS systems 10, one or more locations 22, an entire enterprise wide system 31, or the like.

A response module 86 may collect, store, and process data corresponding to advertisement responses. For example, a response module 86 may collect a count of how many times an advertisement 62 (e.g., one or more advertisements 62 having identical content 80 but different encodings within respective machine-readable codes 66) is scanned. In selected embodiments, one or more machine-readable codes 66 may be encoded with a transaction ID rendering each code 66 thereof (and associated advertisement 62) unique within a POS system 10, location 22, or enterprise-wide system 31. Accordingly, a response module 86 may use transaction-ID data collected from one or more POS systems 10, one or more locations 22, or an entire enterprise-wide system 31 to ensure that the counts collected are not distorted by redundant scans of the exact same machine-readable code 66.

A learning module 88 may use data collected by a presentation module 84 and a response module 86 to calculate one or more success rates, identify statistically significant patterns or trends, or the like. In certain embodiments, a learning module 88 may interpret the data and suggest or implement certain improvements or changes. For example, a learning module 88 may use the effectiveness of a call to action 64 to automatically dictate the frequency that the call to action 64 is shown to consumers (e.g., a learning module 88 may automatically identify one or more advertisements 62 that perform better in certain locations and automatically issue instructions that the one or more advertisements 62 be displayed more frequently in one or more of those locations). Alternatively, or in addition thereto, a learning module 88 may provide a mechanism through which one or more human users may inspect, sort, analyze, or otherwise process or interpret data.

An output module 90 may provide a mechanism for outputting data, plots, graphs, or the like. Alternatively, or in addition thereto, an output module 90 may provide a mechanism for implementing one or more experiments. For example, an output module 90 may enable, support, or issue commands dictating which advertisements 62 or advertisement templates are to be used and how they are to be used.

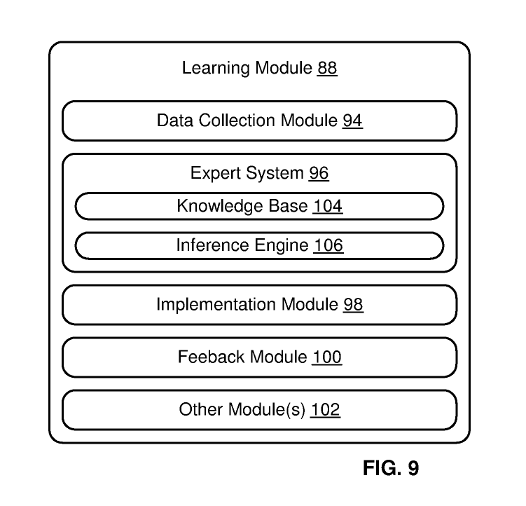

Referring to FIG. 9, a learning module 88 may include any suitable arrangement of sub-components or modules. In certain embodiments, a learning module 88 may include a data collection module 94, expert system 96, implementation module 98, feedback module 100, one or more other modules 102 as desired or necessary, or the like or some combination or sub-combination thereof. The various functions or modules of a learning module 88 may be supported by or run on one or more hardware devices, including a primary computer 12 of a POS system 10, a local server 26, a supervisory server 34, an onsite resource, an offsite resource, or the like or combinations or sub-combinations thereof.

A data collection module 94 may receive and/or collect one or more pieces of data associated with a particular transaction and submit the same to an expert system 96 for analysis. A data collection module 94 may receive or collect any useful data. For example, a data collection module 94 may collect any portion of the data typically associated with a paper receipt 46. Accordingly, for a given transaction, the data collected by a data collection module 94 may include identification of the associated POS system 10, location 22, region, enterprise-wide system 31, etc., identification of the items purchased or returned, an order in which items were entered (e.g., scanned) into a POS system 10, item pricing, tax totals, amount totals (e.g., total amount charged or returned to a customer in association with the transactions), payment type (e.g., whether payment tendered using cash, credit card, check, coupons, government assistance, etc.), other payment information (e.g., credit card type, name of customer), date transaction, time of transaction, or the like or combinations or sub-combinations thereof.

Alternatively, or in addition thereto, a data collection module 94 may collect or receive one or more pieces of data associated with one or more prior transactions (and/or other data previously collected) and submit the same to an expert system 96 for analysis. For example, as part of a transaction, a POS system may receive certain identification information from a customer. Accordingly, a computer system in accordance with the present invention may link the customer with a present, current, or active transaction to one or more records previously collected and stored.

For example, in selected embodiments, a transaction may include the scanning of a card (e.g., membership card, loyalty card, etc.). Alternatively, information identifying a customer may be received via credit card data (e.g., credit card number), the entering of a number uniquely associated with the customer (e.g., the typing in by the customer of a membership number or his or her telephone number), or the like. Accordingly, in some manner, a transaction may include the receipt of some information uniquely identifying a particular customer within the records of a location 22, enterprise-wide system 31, or the like.

Once a link is established between a customer in a present transaction and certain previously collected data corresponding to the customer, that data or some portion thereof may be received and/or collected by a data collection module 94 and submitted to an expert system 96 for analysis. Such data may include identification of gender, age, and other demographic data (e.g., data collected via a membership or loyalty program application), identification of one or more advertisements 62 previously presented to the customer, identification of the responses of customer to the one or more advertisements 62, identification of items previously purchased or returned, an order in which such items were purchased or entered (e.g., scanned into a POS system 10), item pricing, tax totals, amount totals (e.g., total amount charged to a customer within a certain period of time, average transaction charge, weighted average of recent purchases, or the like), preferred or most common payment type (e.g., whether payments typically tendered using cash, credit card, check, coupons, government assistance, etc.), other payment information, or the like or combinations or sub-combinations thereof.

An expert system 96, emulating the decision-making ability of a human expert, may receive the data provided by the data collection module 94 and output a prediction of which of a certain set of advertisements 62 has/have the greatest likelihood of meeting success or eliciting a desired action from the customer (e.g., greatest likelihood of being scanned by a customer using a computing device in his or her possession). In selected embodiments, an expert system 96 may include a knowledge base 104 and an inference engine 106. A knowledge base 104 may comprise a plurality of rules expressing the knowledge to be exploited by the expert system 96. An inference engine 106 may comprise a computer program designed to produce a reasoning based on the rules of the knowledge base 104.

An implementation module 98 may function to implement the prediction of an expert system 96. For example, if an expert system 96 predicts that a particular advertisement 62 or group of advertisements 62 has the greatest likelihood of success, then the implementation module 98 may ensure that the particular advertisement 62 or group of advertisements 62 are presented to the customer. In so doing, an implementation module 98 may work in conjunction with an output module 90.

A feedback module 100 may provide a mechanism through which new rules or updates to existing rules are created or passed to a knowledge base 104. For example, from a response module 86, a feedback module 100 may receive data on the success rates of certain advertisements in certain situations (e.g., in transactions or with customers characterized by certain data). Accordingly, acting on the data, a feedback module may update one or more rules within a knowledge base 104 to reflect current conversion rates, trends, or the like. Thus, a feedback module 100 may ensure that a learning module 88 is continuously learning and improving.

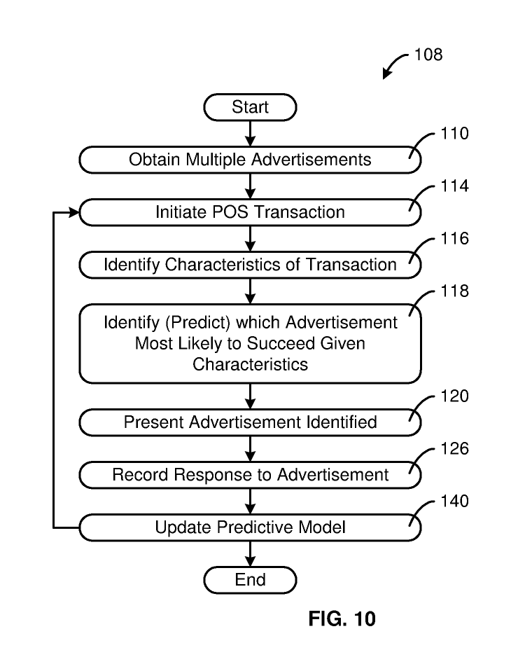

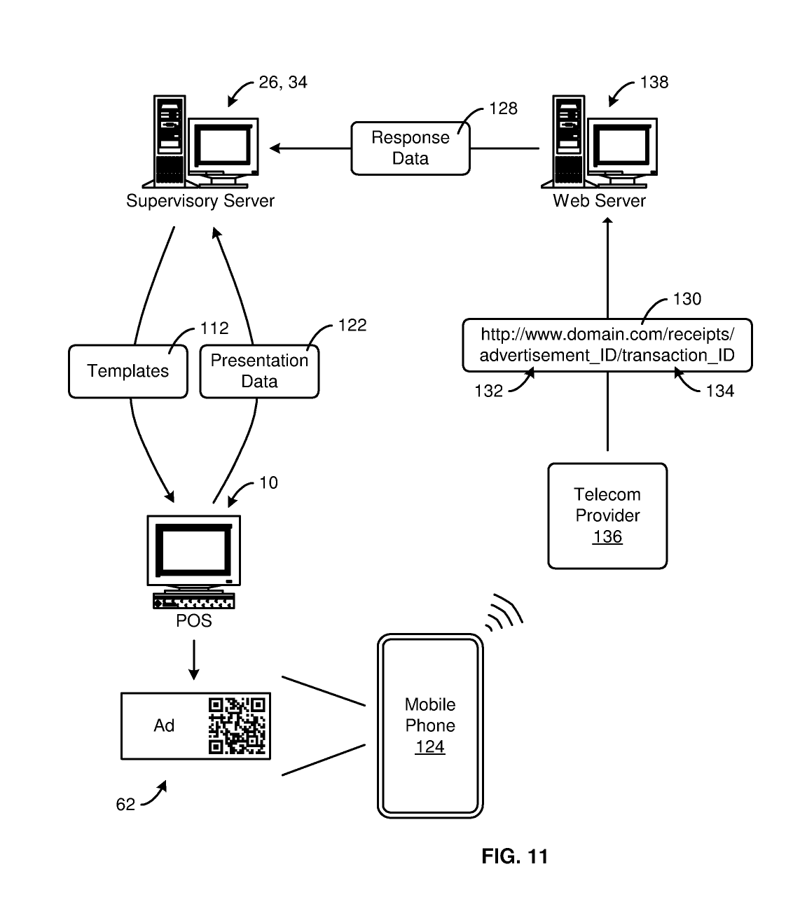

Referring to FIGS. 10 and 11, one method 108 in accordance with the present invention may begin when multiple advertisements 62 are obtained 110 or generated 110. The advertisements 62 may be obtained 110 or generated 110 by a single POS system 10. In selected embodiments, the POS system 10 may base the advertisements 62 on one or more templates 112 provided thereto by a local server 26, supervisory server 34, or some other resource.

A POS system 10 may then initiate 114 a POS transaction. In association with the transaction, one or more characteristics (e.g., one or more pieces of data) corresponding thereto may be identified 116. For example, any portion of the data typically associated with a paper receipt 46 may be identified 116. Using these characteristics, a system (e.g., an expert system 96) in accordance with the present invention may identify 118 or predict 118 which advertisement 62 or advertisements 62 are most likely to elicit a desired response with the customer.

Once identified 118 or predicted 118, the advertisement 62 or advertisements 62 may be presented 120 to the customer. For example, a receipt 46 generated at the end of the POS transaction may include an advertisement 62. Alternatively, or in addition thereto, an advertisement 62 (or a plurality of advertisements 62) may be presented 120 via a customer-facing display 20a at some time during or after a transaction. The number and identity of the advertisement 62 or advertisements 62 presented 120 may be recorded. In selected embodiments, such data (e.g., presentation data 122) may be passed from the POS system 10 to a local server 26, a supervisory server 34, or the like.

In selected embodiments, at some point, a first advertisement 62 may be replaced by a second advertisement 62, different from the first advertisement 62. For example, as more characteristics are identified 116 during a transaction (e.g., as more items are scanned by a POS system 10), a prediction 118 as to which advertisement 62 is mostly likely to succeed may change. Accordingly, the advertisement 62 displayed 120 may change.

For example, after one item is identified 116 (e.g., scanned), it may be determined 118 that one advertisement 62 would have the greatest likelihood of success. Accordingly, that advertisement 62 may be displayed 120 on a customer-facing display 20a (e.g., a card reader 18b). Later in the transaction, after another item is identified 116 (e.g., scanned), it may be determined 118 that a different advertisement 62 would have the greatest likelihood of success. Accordingly, that different advertisement 62 may be displayed 120 on the customer-facing display 20a. In selected embodiments, each new determination 118 may be based solely on the new characteristics identified 116 (e.g., new items scanned since the last determination 118). Alternatively, each new determination 118 may be based on the full set of characteristics that have been identified 116 up to that point in the particular transaction.

Should a customer feel so inclined, he or she may scan a machine-readable code 66 of an advertisement 62 presented 120 to him or her. For example, a customer may scan an advertisement 62 using the camera of a mobile telephone 124. This scan may be passed to and recorded 126 by a local server 26, a supervisory server 34, other resource, or the like. However, the path of such data (e.g., response data 128) need not follow the same path as the presentation data 122.

For example, in selected embodiments, a machine-readable code 66 may be encoded with a URL 130. In addition to designating a particular resource, a URL 130 may also include certain identifications. For example, a URL may include an advertisement ID 132 and a transaction ID 134. In operation, a URL 130 may be passed from a customer (e.g., from a mobile telephone 124 of a customer) to an Internet Service Provider (e.g., a telecommunications provider 136). As a result, a request may reach a web server 138 corresponding to the URL 130. The request may include the advertisement ID 132 and transaction ID 134. Thus, a web server 138 may collect these identifications 132, 134 and pass them as response data 128 to a local server 26, a supervisory server 34, other resource, or the like. Accordingly, the fact that a particular advertisement 62 (e.g., machine-readable code 66 associated with the particular advertisement 62) was scanned may be noted and recorded 126.

Using the data 122, 128 collected, a local server 26, supervisory server 34, or the like may calculate a success rate for the one or more advertisements 62 presented 120. Information (e.g., facts, trends, or the like) may be learned from the respective success rates and the underlying statistical information. Accordingly, the information learned may be used to update 140 the predictive module (e.g., update, revise, or replace one or more rules within the knowledge base 104 of an expert system 96) so that is will perform better in the future. This process 108 or certain portions thereof may be iterated to progressively improve the rate at which one or more purposes behind an advertisement 62 are accomplished.

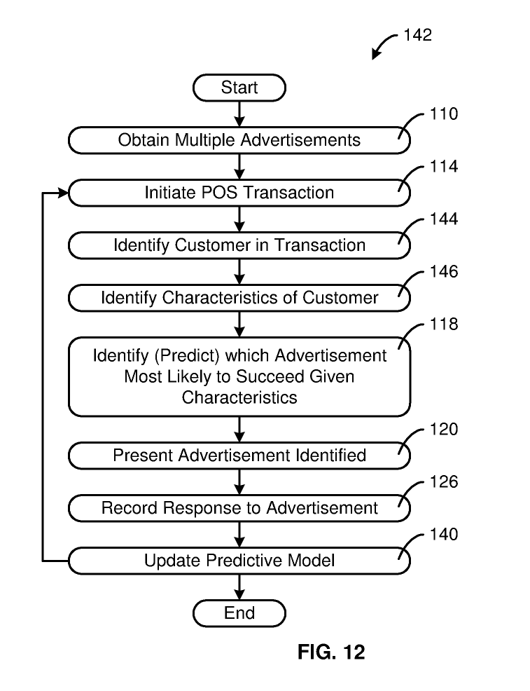

Referring to FIG. 12, in selected embodiments, certain methods 142 in accordance with the present invention may use previously stored characteristics or data to predict 118 or assist in predicting 118 which advertisement 62 or advertisements 62 are most likely to elicit a desired response with the customer. For example, a method 142 may include the step of identifying 144, as part of the transaction, the customer (e.g., linking 144 the customer with the records of a POS system 10, location 22, enterprise-wide system 31, or the like). Once this identification 144 has taken place, then the characteristics or data previously stored (or a portion thereof) may be identified 146 or linked 146 to the transaction at hand. Accordingly, the characteristics or data previously stored (or a portion thereof) may be used to identify 118 or predict 118 which advertisement 62 or advertisements 62 are most likely to elicit a desired response with the customer.

The flowchart and block diagrams in FIGS. 10-12 illustrate the architecture, functionality, and operation of possible implementations of systems, methods, and computer program products according to one embodiment of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for selecting an advertisement, the method comprising:
identifying a computer system comprising a point-of-sale system and an expert system;
storing, by the computer system, first data corresponding to a customer;
conducting, after the storing, a point-of-sale transaction involving the customer, one or more items, and the point-of-sale system;
generating, by the computer system, a plurality of advertisements, each comprising a machine-readable code encoded with a transaction identification unique to the transaction;
linking, by the computer system, the transaction to the customer;
passing the first data to the expert system;
identifying, by the expert system using the first data, an advertisement of the plurality of advertisements most likely to elicit a desired response from the customer; and
presenting the advertisement to the customer.

2. The method of claim 1, wherein the presenting comprises displaying the advertisement on a customer-facing display.

3. The method of claim 1, wherein the presenting comprises printing the advertisement on a paper receipt documenting the transaction.

4. The method of claim 1, wherein the passing comprises passing first data comprising an identification of a gender of the customer.

5. The method of claim 1, wherein the passing comprises passing first data comprising an identification of one or more items purchased by the customer in one or more transactions occurring prior to the transaction.

6. The method of claim 1, wherein the passing comprises passing first data comprising one or more total costs charged to the customer in one or more transactions occurring prior to the transaction.

7. The method of claim 1, wherein the passing comprises passing second data to the expert system, the second data comprising an identification of at least a portion of the one or more items.

8. The method of claim 1, wherein the linking comprises scanning, by the point-of-sale system, a card corresponding to the customer.

9. The method of claim 1, wherein the linking comprises inputting a telephone number into the point-of-sale system.

10. The method of claim 1, wherein the linking comprises inputting, by the customer, a telephone number into the point-of-sale system.

11. The method of claim 1, wherein the generating comprises generating each advertisement of the plurality of advertisements with a call to action unique in at least one manner among the plurality of advertisements.

12. The method of claim 11, wherein the generating further comprises generating each advertisement of the plurality of advertisements with the machine-readable code encoded with a call identification unique to the call to action corresponding thereto.

13. A method for selecting an advertisement, the method comprising:
identifying a computer system comprising a point-of-sale system and an expert system;
storing, by the computer system, first data corresponding to a customer;
conducting, after the storing, a point-of-sale transaction involving the customer, one or more items, and the point-of-sale system;
generating, by the computer system, a plurality of advertisements, each comprising a call to action and a machine-readable code, the call to action being unique in at least one manner among the plurality of advertisements, the machine-readable code encoded with a transaction identification unique to the transaction;
linking, by the computer system, the transaction to the customer;
passing the first data to the expert system;
identifying, by the expert system using the first data, an advertisement of the plurality of advertisements most likely to be scanned by the customer into a computing device possessed by the customer; and
presenting the advertisement to the customer.

14. The method of claim 13, wherein the presenting comprises displaying the advertisement on a customer-facing display.

15. The method of claim 14, wherein the presenting comprises printing the advertisement on a paper receipt documenting the transaction.

16. The method of claim 14, wherein the passing comprises passing first data comprising at least one of:
an identification of a gender of the customer;
an identification of one or more items purchased by the customer in one or more transactions occurring prior to the transaction; and
one or more total costs charged to the customer in one or more transactions occurring prior to the transaction.

17. The method of claim 16, wherein the passing further comprises passing second data to the expert system, the second data comprising an identification of at least a portion of the one or more items corresponding to the transaction.

18. The method of claim 14, wherein the generating comprises generating each advertisement of the plurality of advertisements with the machine-readable code encoded with a call identification unique to the call to action corresponding thereto.

19. A method for selecting an advertisement, the method comprising:
identifying a computer system comprising a point-of-sale system and an expert system, the point-of-sale system comprising a customer-facing computer display;
storing, by the computer system, first data corresponding to a customer;
conducting a point-of-sale transaction involving the customer, one or more items, and the point-of-sale system;
generating, by the computer system, a plurality of advertisements, each comprising a call to action and a machine-readable code, the call to action bring unique in at least one manner among the plurality of advertisements, the machine-readable code encoded with a transaction identification unique to the transaction;
linking, by the computer system, the transaction to the customer;
passing the first data to the expert system;
identifying, by the expert system based on the first data, a first advertisement of the plurality of advertisements most likely to be scanned by the customer into a computing device possessed by the customer; and
presenting, via the customer-facing display, the first advertisement to the customer prior to completion of the transaction.

20. The method of claim 19, further comprising:
passing second data corresponding to the one or more items of the transaction to the expert system;
identifying, by the expert system using the second data or the first and second data, a second advertisement of the plurality of advertisements most likely to be scanned by the customer into a computing device possessed by the customer; and
presenting the second advertisement to the customer.
